(19) United States
(12) Patent Application Publication
(10) Pub. No.: US 2026/0315984 A1
(43) Pub. Date: Oct. 15, 2026

(54) METHOD AND APPARATUS FOR SEPARATING CO2 BY PARTIAL CONDENSATION AND/OR DISTILLATION

(71) Applicant: L'Air Liquide, Societe Anonyme pour l'Etude et l’Exploitation des Procedes Georges Claude, Paris (FR)

(72) Inventors: Felix PERE, Champigny Sur Marne (FR); Mathieu LECLERC, Champigny Sur Marne (FR); Martin RAVENTOS, Champigny Sur Marne (FR)

(21) Appl. No.: 19/482,494

(22) PCT Filed: Apr. 19, 2024
(86) PCT No.: PCT/EP2024/060655

§ 371 Date: Nov. 7, 2025

(30) Foreign Application Priority Data
May 17, 2023 (FR) FR2304896

(51) Int. Cl. B01D 53/00; B01D 53/14; B01D 53/26; F23J 15/02; F25J 3/06

(52) U.S. Cl. CPC B01D 53/002; B01D 53/1475; B01D 53/261; B01D 53/265; F23J 15/02; F25J 3/067; B01D 2252/204; B01D 2256/22; B01D 2257/504; B01D 2257/80; F23J 2215/50

(57) ABSTRACT

In a method for separating CO2 by partial condensation and/or distillation—a first gas containing hydrogen, water and carbon dioxide is compressed in a compressor, dried in an adsorption drying unit and then separated by partial condensation and/or distillation to produce a CO2-enriched fluid and—a second gas, containing carbon dioxide, hydrogen and water, originating from an absorption separation process, is cooled in order to condense at least a portion of the water that it contains, the water is separated from the gas forming a dried gas and the dried gas is mixed with the first gas upstream of the adsorption drying unit and optionally upstream of the compressor.

### CROSS REFERENCE TO RELATED APPLICATIONS

This application is a § 371 of International PCT Application PCT/EP2024/060655, filed Apr. 19, 2024, which claims the benefit of FR2304896, filed May 17, 2023, both of which are herein incorporated by reference in their entireties.

### FIELD OF THE INVENTION

The present invention relates to a process and to an apparatus for separating CO2 by partial condensation and/or distillation. In particular, it relates to such a process supplied with a CO2-enriched gas originating from a process for separating CO2 by absorption.

### BACKGROUND OF THE INVENTION

The removal of CO2 is already widely deployed on an industrial scale, mainly using absorption processes. These processes, whether physical, chemical or physicochemical, all use a liquid solvent to remove one or more compounds (in this case CO2) from a gaseous stream.

The rich solvent is then regenerated and releases the captured compounds. This regeneration is generally carried out by expansion and supply of heat.

Applied to the removal of CO2, these processes all produce CO2 from near atmospheric pressure to ~3 bara, depending on the process scheme. In addition, many absorption processes (amine scrubbing, hot potassium scrubbing, Purisol®, etc.) use aqueous solvents, and thus release wet CO2.

This production of wet CO2 at low pressure is not a problem when the removal of the CO2 is justified by the specifications of the downstream process (synthesis, cryogenic treatment, etc.). However, CCS (carbon capture and sequestration) specifications generally require dry, pressurized or liquefied CO2. CO2 originating from absorption processes must therefore be compressed, dried and possibly liquefied in order to be integrated into CCS schemes. This requires additional equipment and operating expenses.

It is known to separate CO2 from a waste gas of a hydrogen-producing PSA. The waste gas is compressed and separated by partial condensation and/or distillation. While the waste gas contains water, the latter is in a state of low saturation and therefore the waste gas can be compressed without the water condensing upstream of the separation by partial condensation and/or distillation. A dryer is therefore necessary upstream of the partial condensation and/or distillation.

It is also known from WO 2015/075071 to mix a CO2-enriched gas originating from amine scrubbing with the waste gas of an H2 PSA and to separate the mixture by partial condensation and/or distillation.

It is also known from US2013/9156686 to use amine scrubbing to produce a CO2-enriched fluid and a CO2-depleted fluid, to separate the CO2-depleted fluid by PSA, producing hydrogen and another, hydrogen-depleted, gas, the other gas being separated at low temperature in order to recover the CO2 that it contains.

The wet CO2 generated by the absorption processes can be directly integrated into the process for separating the waste from the H2 PSA by partial condensation and/or distillation. Being (in most cases) wet and available at low pressure, it is ideally injected into the separation process at the inlet of the compressor for the waste of the H2 PSA.

Since CO2-enriched gases originating from the absorption process are generally available at about 1.3 bara, a blower may be needed in order to increase the pressure of the CO2-enriched gas from the absorption process to the correct pressure. Such a device might also be necessary if the two processes are not close to each other.

Injecting a wet stream coming from the absorption process into the gaseous waste of the PSA could be very detrimental to the partial condensation and/or distillation process, since it increases the temperature of the dew point of the gaseous waste of the H2 PSA, and therefore reduces the pressure attainable without condensation. Drying must then be carried out at a lower pressure, which is costly both in terms of investment and in terms of operating costs.

The most relevant solution is therefore to cool the CO2-enriched wet stream coming from the absorption process in order to condense as much water as possible, before mixing it with the waste of the H2 PSA.

By cooling the wet stream in order to condense the water that it contains, the water level can be desaturated to a level that allows the two gases to be compressed together.

Obviously, the compressor and the apparatus for separation by partial condensation and/or distillation will be larger in order to be able to treat the two mixed gases.

WO2010/066972 describes a CO2 separation process in which a gaseous mixture comprising hydrogen, carbon monoxide, carbon dioxide, methane and water is separated using an H2 PSA that produces a dry waste, the water having been removed by CO2 PSA.

### SUMMARY OF THE INVENTION

One subject of the invention provides a process for separating CO2 by partial condensation and/or distillation, wherein:
i) a first gas containing hydrogen, water and carbon dioxide is compressed in a compressor, dried in an adsorption drying unit and then separated by partial condensation and/or distillation in order to produce a fluid enriched in CO2,
ii) a second gas, containing carbon dioxide, hydrogen and/or nitrogen and also water, and also possibly carbon monoxide and/or methane, originating from an absorption separation process, is cooled in order to condense at least a portion of the water it contains, the water is separated from the gas, forming a dried gas, and the dried gas is mixed with the first gas upstream of the adsorption drying unit and optionally upstream of the compressor.

According to other optional features:
the dried gas is mixed with the first gas upstream of the adsorption drying unit and downstream of the compressor.
the second gas is compressed upstream of the cooling up to the pressure of the first gas upstream of the adsorption drying unit.
the second gas is compressed upstream of the cooling up to the pressure at the inlet of the adsorption drying unit.
the second gas is compressed upstream of the cooling up to a pressure of at least 9 bar abs.
the second gas is cooled by indirect heat exchange with water.
the second gas is cooled by indirect heat exchange with a fluid, optionally enriched in CO2, produced by the partial condensation and/or the distillation, optionally to a temperature of below 0 °C.
the dried second gas is heated by heat exchange with the second gas upstream of the cooling.
the first gas is a waste gas from an adsorption separation process that produces a gas enriched in hydrogen and a gas depleted in hydrogen, which is the waste gas.
the content of CO2 and/or of water in the first gas is lower than that in the second gas.
the content of CO2 in the mixture formed by mixing the dried gas with the first gas is greater than that in the first gas.
the flow rate of the first gas is greater than that of the second gas.
the ratio between the flow rates of the first and of the second gas is at least equal to 10.
the second gas originates from an amine or potassium carbonate scrubbing unit.
flue gases are separated by the absorption process in order to produce the second gas.
a synthesis gas is separated by the absorption process in order to produce the second gas.

Another subject of the invention provides an apparatus for separating CO2 by partial condensation and/or distillation, comprising a compressor, an adsorption drying unit, a unit for separation by partial condensation and/or distillation, means for sending a first gas containing hydrogen, water and carbon dioxide to be compressed in the compressor, means for sending the compressed first gas to be dried in the adsorption drying unit and means for sending the compressed and dried first gas to be separated by partial condensation and/or distillation in order to produce a fluid enriched in CO2, a cooler, a phase separator, means for sending a second gas, containing carbon dioxide, hydrogen and/or nitrogen and also water, and also possibly carbon monoxide and/or methane, originating from an absorption separation process, to the cooler to be cooled in order to condense at least a portion of the water it contains, means for discharging the water separated from the gas from the phase separator, means for discharging a dried gas from the phase separator and means for sending the dried gas to be mixed with the first gas upstream of the adsorption drying unit and optionally upstream of the compressor.

Preferably, the absorption separation process is a CO2-selective physicochemical process.

Preferably, the absorption separation process is an amine scrubbing process.

The apparatus may comprise means for sending the dried gas to be mixed with the first gas upstream of the adsorption drying unit and downstream of the compressor.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments. FIG. 1 represents a process according to the invention.

FIG. 2 represents a process according to the invention.

FIG. 3 represents a process according to the invention.

FIG. 4 represents a process according to the invention.

### DETAILED DESCRIPTION OF THE INVENTION

In FIG. 1, a flow 3 from an absorption unit A contains carbon dioxide, water, hydrogen and/or nitrogen and optionally carbon monoxide and/or methane. The flow 3 typically contains between 6 and 7 mol % of water. The absorption unit may use a CO2-selective physicochemical process, and for example may use amine scrubbing, hot potassium carbonate scrubbing, Purisol®-type scrubbing with NMP scrubbing, and produces the flow 3 at substantially atmospheric pressure or at higher pressures. In certain cases, it is therefore necessary to boost the flow 3 with a blower B in order to bring its pressure to approximately 1.5 bars abs or more. The flow 3 is then cooled by indirect heat exchange with water 11 in the cooler K in order to condense at least a portion 7 of the water it contains. The dried gas 9 exits the separator S used to remove the water 7 and is sent to be mixed with the waste gas 1 from a process for separating hydrogen by pressure swing adsorption P. This first gas 1 contains carbon dioxide, hydrogen and water and usually has a lower carbon dioxide content than the flow 3. The first gas 1 usually has a lower content of water than the flow 3. The flow rate of the first gas 1 is preferably greater than that of the second gas 3.

The separation of such a flow is well known and is described, for example, in U.S. Pat. No. 8,021,464.

The mixture 15 is then treated in a separation unit C. It is compressed up to a pressure above 9 bar abs, or even above 20 bar, dried by adsorption in order to remove the remnants of water and then cooled and separated by partial condensation and/or distillation in order to obtain at least one gas and/or at least one liquid enriched in CO2 and containing, for example, at least 90 mol %, or even at least 95 mol %, CO2, and a gas enriched in hydrogen.

The blower B, if present, can compress the gas 9 up to the pressure of the gas 1 or up to the pressure at the inlet of the dryer 19 of FIG. 4.

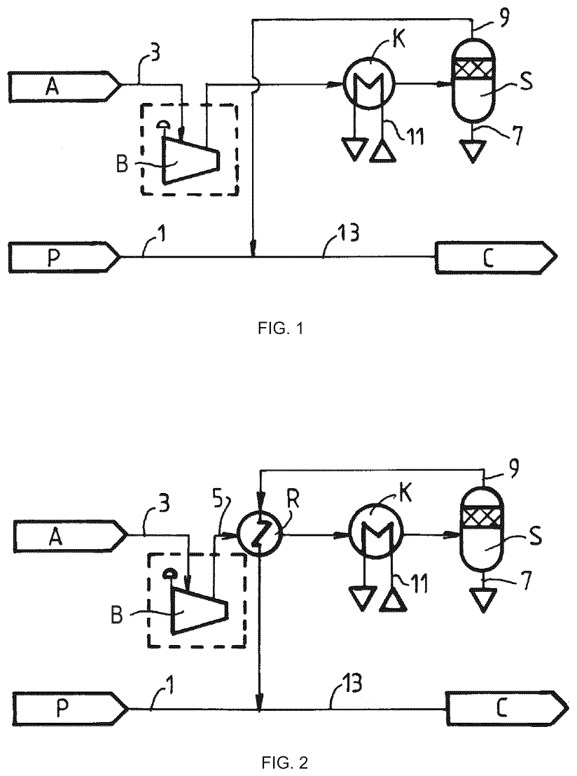

In FIG. 2, the flow 3 is cooled in a cooler R upstream of the cooler K and downstream of the absorption unit A and possibly of the blower B. This cooler R enables indirect heat exchange between the dried gas 9 coming from the separator S and the flow 3 to be cooled. The gas cooled in the cooler R is mixed with the first gas 1 as in FIG. 1. This makes it possible to reduce the consumption of water 11.

In certain cases, the flow 3 is available at a higher pressure than the first gas 1 and therefore the flow 9 can be mixed with the waste 3 after the waste 3 has been compressed in at least one stage of the compressor of unit C.

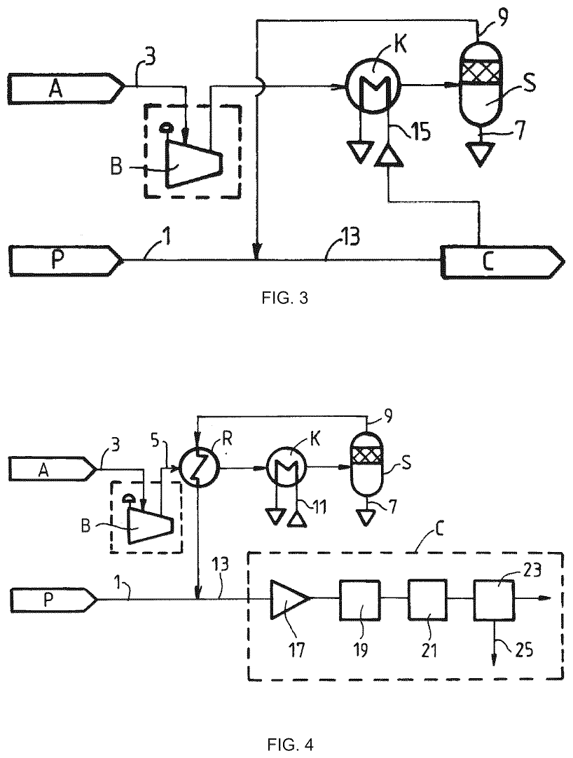

In FIG. 3, the flow 3 is cooled in order to condense the water at least from a liquid 15 enriched in CO2 compared to the mixture originating from at least one phase separator of the unit C in which the mixture 13 is separated. The liquid is sent to the cooler K at a temperature of less than 0 °C and is vaporized in the cooler K. The liquid 15 may alternatively constitute a portion of the bottom liquid of a distillation column, this liquid comprising at least 90 mol % CO2.

The use of such a flow makes it possible to reduce the consumption of water 11 and furthermore effects the vaporization necessary to produce the liquid 15 in gaseous form to be sent to the customer.

FIG. 4 shows a version of FIG. 1 with the unit C illustrated in more detail. The unit C comprises a compressor 17, an adsorption drying unit (TSA) 19, an exchange line 21 for cooling the compressed and dried mixture and a separation section 23 for separation by partial condensation and/or distillation, producing at least one fluid enriched in CO2 25 compared to the mixture 13.

The invention is of the most interest when the flow rate of the gas 3 is lower than the flow rate of the gas 1, since mixing the flows 1 and 9 requires oversizing of the unit C.

The invention applies particularly to the case where the ratio between the flow rate of the gas 3 and that of the flow 1 is less than 0.1, the exact ratio depending on economic factors.

Nevertheless, in terms of investment, the equipment for compressing and treating the flows 1 and 3 together is less expensive than that for separating them separately.

Moreover, since the flow 3 is often richer in CO2 than the flow 1, the act of adding the flow 9 to the gas 1 increases the molecular weight of the gas 1 and makes the compression in the unit C more efficient. Separation by partial condensation and/or distillation is also more efficient when the flow to be separated is richer in CO2.

On the other hand, the waste gas of the H2 PSA experiences fluctuations in composition due to the cyclicity of the PSA process. Mixing with a gas of fixed composition makes it possible to mitigate the effect of these variations in composition on the compressor and the downstream separation process.

Lastly, the unit C makes it possible to remove impurities remaining in the flow 3, for example nitrogen and/or hydrogen, carbon monoxide and methane, whereas the absorption does not make it possible to remove them. Thus, the unit C makes it possible to produce good quality CO2 with the CO2-rich gas of an absorption unit.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-12. (canceled)

13. A process for separating CO2 by partial condensation and/or distillation, the method comprising the steps of:
i) compressing a first gas containing hydrogen, water and carbon dioxide in a compressor, drying the first gas in an adsorption drying unit to form a dry first gas, and then separating the dry first gas by partial condensation and/or distillation in order to produce a fluid enriched in CO2;
ii) cooling a second gas, containing carbon dioxide, hydrogen, water, and at least one of nitrogen, carbon monoxide, and methane, originating from an absorption separation process, in order to condense at least a portion of the water within the second gas, separating the water from the second gas to forming a dried second gas, and mixing the dried second gas with the first gas upstream of the adsorption drying unit and optionally upstream of the compressor.

14. The process as claimed in claim 13, wherein the second gas is compressed upstream of the cooling up to the pressure of the first gas upstream of the adsorption drying unit.

15. The process as claimed in claim 13, wherein the second gas is cooled by indirect heat exchange with water.

16. The process as claimed in claim 13, wherein the second gas is cooled by indirect heat exchange with a fluid enriched in CO2, produced by the partial condensation and/or the distillation, to a temperature of below 0 °C.

17. The process as claimed in claim 13, wherein the dried second gas is heated by heat exchange with the second gas upstream of the cooling.

18. The process as claimed in claim 13, wherein the first gas is a waste gas from an adsorption separation process that produces a gas enriched in hydrogen and a gas depleted in hydrogen, which is the waste gas.

19. The process as claimed in claim 13, wherein the content of CO2 and/or of water in the first gas is lower than that in the second gas.

20. The process as claimed in claim 13, wherein the content of CO2 in the mixture formed by mixing the dried gas with the first gas is greater than that in the first gas.

21. The process as claimed in claim 13, wherein the ratio between the flow rates of the first and of the second gas is at least equal to 10.

22. An apparatus for separating CO2 by partial condensation and/or distillation, the apparatus comprising:
a compressor;
an adsorption drying unit;
a unit for separation by partial condensation and/or distillation;
means for sending a first gas containing hydrogen, water and carbon dioxide to be compressed in the compressor;
means for sending the compressed first gas to be dried in the adsorption drying unit and
means for sending the compressed and dried first gas to be separated by partial condensation and/or distillation in order to produce a fluid enriched in CO2;
a cooler;
a phase separator;
means for sending a second gas, containing carbon dioxide, hydrogen, water, and at least one of nitrogen, carbon monoxide, and methane, originating from an absorption separation process, to the cooler to be cooled in order to condense at least a portion of the water within the second gas contains;
means for discharging the water separated from the second gas from the phase separator to for a dried second gas, means for discharging the dried second gas from the phase separator; and
means for sending the dried second gas to be mixed with the first gas upstream of the adsorption drying unit and optionally upstream of the compressor.

23. The apparatus as claimed in claim 22, wherein the absorption separation process is a CO2-selective physicochemical process.

24. The apparatus as claimed in claim 23, wherein the adsorption separation process is an amine scrubbing process.
